(19) United States
(12) Patent Application Publication
(10) Pub. No.: US 2015/0346973 A1
(43) Pub. Date: Dec. 3, 2015

(54) SEAMLESSLY ENABLING LARGER UI

(71) Applicant: Apple Inc., Cupertino, CA (US)

(72) Inventors: Joshua H. Shaffer, Cupertino, CA (US); Jason C. Beaver, San Jose, CA (US); Craig Federighi, Los Altos Hills, CA (US)

(21) Appl. No.: 14/690,009

(22) Filed: Apr. 17, 2015

Related U.S. Application Data
(60) Provisional application No. 62/006,220, filed on Jun. 1, 2014.
(60) Provisional application No. 62/086,636, filed on Dec. 2, 2014.

(51) Int. Cl. G06F 3/0484

(52) U.S. Cl. CPC G06F 3/04845; G06F 3/04842; G06F 3/04847

(57) ABSTRACT

A system and method are disclosed for displaying a graphical user interface (GUI) on a device display. The display has dimensions of a first size. The GUI is configured for output on a display of the first size, but the device reports the second size. The reporting is responsive to receiving a request to configure the GUI for output on a display of a second size, according to some embodiments. The GUI, configured for output on a display of the second size, is displayed on the device display that has dimensions of the first size.

### CROSS REFERENCE TO RELATED APPLICATIONS

This application claims the benefit of U.S. Provisional Application No. 62/006,220, filed Jun. 1, 2014, and of U.S. Provisional Application No. 62/086,636, filed Dec. 2, 2014, which are incorporated by reference in their entirety.

### BACKGROUND

1. Field of Art

This application relates generally to electronic devices with touch-sensitive surfaces, configured for resizing displayed screens using gesture inputs.

2. Description of the Related Art

Mobile devices have become ubiquitous in recent years due to their small size and portability. However, the small size of the mobile devices poses a problem to users who cannot clearly see a graphical user interface (GUI) on their mobile device's display. Current methods of enlarging a display on a mobile device result in pixilation, loss of resolution, and other visual artifacts (e.g., graphical defects) in the displayed GUI. Users would like a way of re-sizing their GUI on their mobile device displays while maintaining a defect-free interface.

### SUMMARY OF THE INVENTION

Accordingly, there is a need for electronic devices with more efficient systems and methods for generating displays of different sizes. A first electronic device (e.g., a personal computer, a tablet computer, a smartphone, a PDA, or other portable multifunction device) displays a graphical user interface (GUI) configured for output (display) on a display of a first size. The first size is the size of the display on the first device, and is the “native size” of the display according to some embodiments. The device reports, to an application configured on the device, the size of the display as a second size that is different from the first size. The application optionally is a first-party application, third-party application, or an operating system that the display on the device. The reporting is in response to a request received at the first device to configure the GUI for output on a display of a second size instead of the first size according to some embodiments. The second size optionally corresponds to the size of a display on a second electronic device, different than the first electronic device. For example, the request optionally is for the first device, e.g., a smartphone, to configure the GUI for output on a tablet-size screen. In some embodiments, the second size is indicated by a virtual device ID sent to the device as part of the request.

The device receives a GUI from the application according to some embodiments. The device optionally configures the GUI for output on a display of the second size. In some embodiments, the GUI is configured by mapping the GUI to a virtual canvas of the first size, stored in memory, and configuring the virtual canvas to the second size. The GUI, configured for output (display) on a display of the second size, is displayed on the device display having the first size.

Since developers typically design GUIs for set of known sizes of devices, any of those sizes optionally are used to apply to other device sizes per the methods described herein. Thus, application developers do not need to design additional GUIs for display at different sizes as well. Thus, the disclosed system and method reduces memory usage as compared to other techniques.

### BRIEF DESCRIPTION OF DRAWINGS

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5 is an interaction diagram illustrating a method for outputting a GUI on a device, in accordance with some embodiments.

FIG. 6 is a flowchart illustrating a method for generating a display on a mobile device, in accordance with some embodiments.

FIG. 7 illustrates GUIs during a process for generating a GUI at the second size by changing the display resolution of graphics in the GUI, in accordance with some embodiments.

FIG. 8 is an interaction diagram illustrating a method for processing touch input on a display, in accordance with some embodiments.

FIG. 9 is a flowchart illustrating a method for receiving touch input on a display, in accordance with some embodiments.

FIG. 10 illustrates receiving touch input on a GUI, in accordance with some embodiments.

FIG. 11 depicts three different portable multifunction devices displaying an exemplary user interface for a menu of applications, according to some embodiments.

FIG. 12 depicts portable multifunction devices showing user interfaces with two differently sized sets of application icons and other display elements on devices, according to some embodiments.

FIG. 13 depicts portable multifunction devices showing user interfaces with two differently sized sets of application icons and other display elements on devices, according to some embodiments.

FIG. 14 depicts portable multifunction devices side by side with different sized portable multifunction devices, according to some embodiments.

FIG. 15 depicts portable multifunction devices side by side with different sized portable multifunction devices, according to some embodiments.

### DETAILED DESCRIPTION

An electronic device (e.g., a personal computer, a tablet computer, a smartphone, a PDA, or other portable multifunction device) displays a graphical user interface (GUI) configured for display on a display at a first size. The first size is the size of the display on the device and is considered the “native” size of the device. The device receives a request to display the same GUI configured for display on a screen of a second size. The second size corresponds to a display on a second electronic device. For example, the request optionally is to display a GUI configured for display on an iPad® from Apple Inc. of Cupertino, Calif. on a display of an iPhone® from Apple Inc. of Cupertino, Calif.

In some embodiments, the size of the display is indicated by a device ID. The device ID indicates the type of display or size of display the GUI is to be displayed on. A device ID for the electronic device having a display at a first size is replaced by a virtual device ID. The virtual device ID indicates that the GUI is to be configured for output (display) on a display at the second size. The second size is reported to the device. The virtual device ID optionally is reported to a software program, such as a first-party application, third-party application, or an operating system configured on the device.

The GUI is configured to be output on a display of the second size. This can include mapping the GUI to a virtual canvas stored in memory on the device. The virtual canvas represents the display the GUI is displayed on and is initially of the first size, matching the size of the display of the device. The virtual canvas is configured so that the size of the virtual canvas matches the second size. The GUI, configured for display on a display of the second size, is displayed on the device display having the first size.

In some embodiments, the electronic device includes a touch-sensitive display (i.e., “touch-screen”) that displays the GUI configured for output at the second size. The GUI configured for display on a display of the second size is displayed on the touch-screen that has physical dimensions corresponding to the first size. The touch-screen receives touch input in the form of one or more contacts. The touch input is recorded with respect to a virtual canvas. The virtual canvas corresponds to a touch-screen display of the first size. The touch input with respect to the virtual canvas that corresponds to a touch-screen display of the second size is reported to an application on the device. This method of processing touch-screen input allows the device to receive and map touch-screen input to a GUI configured for display on a display at the second size, different than the native size of the device.

### Exemplary Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments optionally are practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

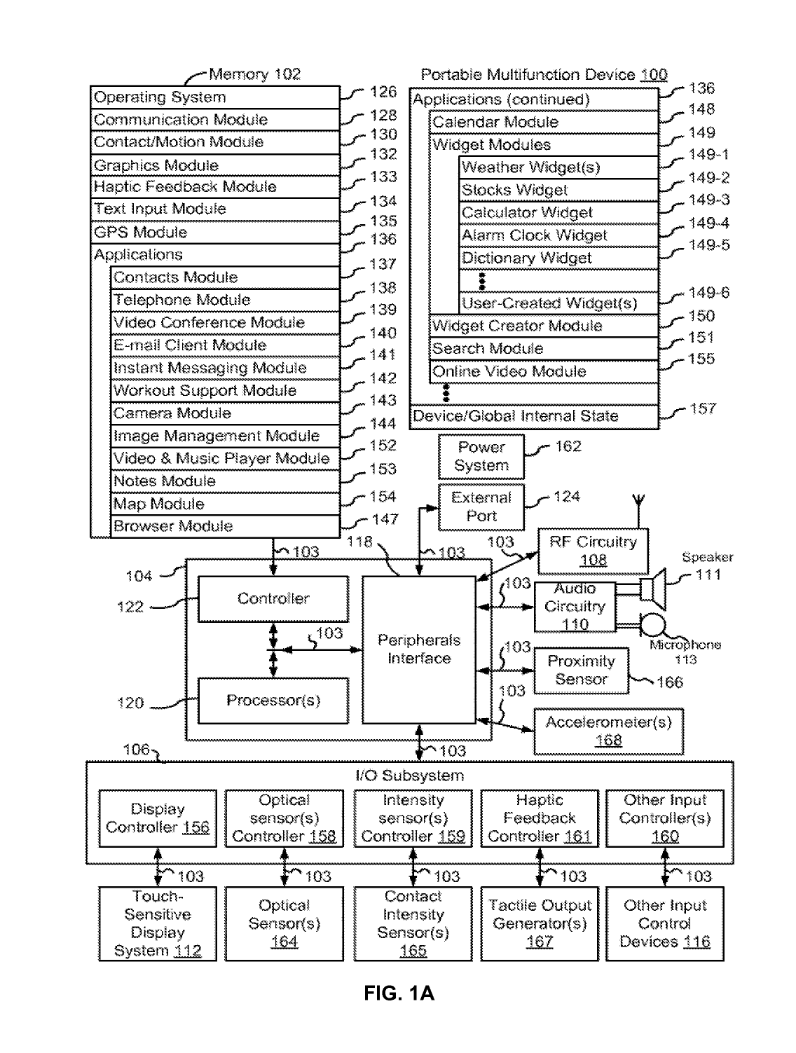

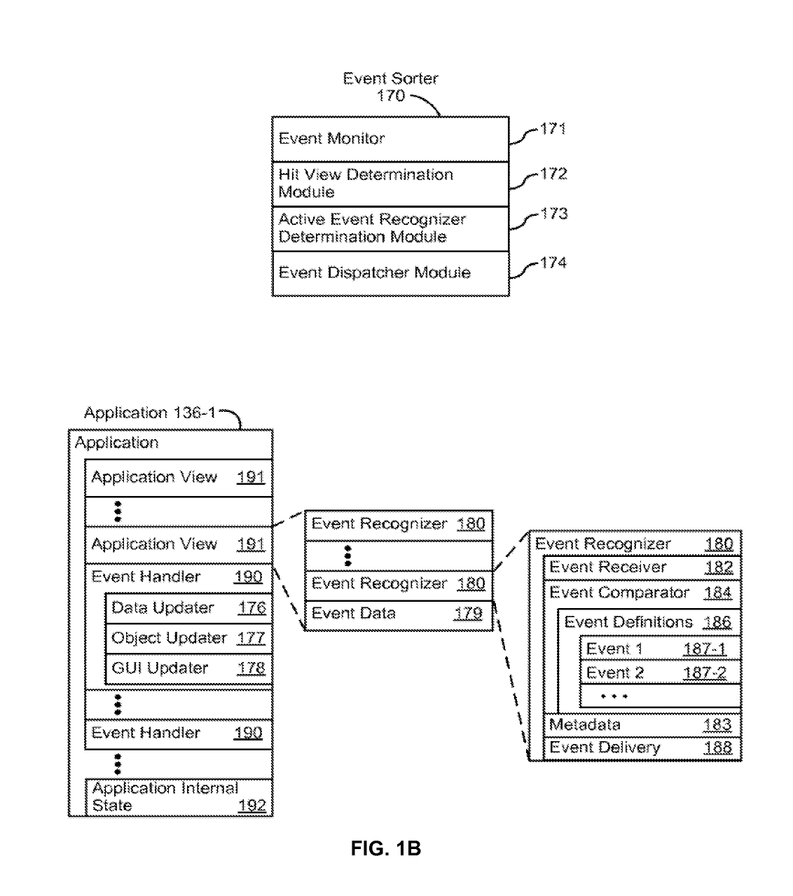

Attention is now directed toward embodiments of portable devices with touch-sensitive displays. FIG. 1A is a block diagram illustrating portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch sensitive surface, or to a substitute (proxy) for the force or pressure of a contact on the touch sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of hardware and software, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU 120 and the peripherals interface 118, is, optionally, controlled by memory controller 122.

Peripherals interface 118 optionally is used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.1ln), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Services (IMPS)), and/or Short Messaging Service (SMS), or any other suitable communications protocol, including communications protocols not yet developed as of the filing date of this document.

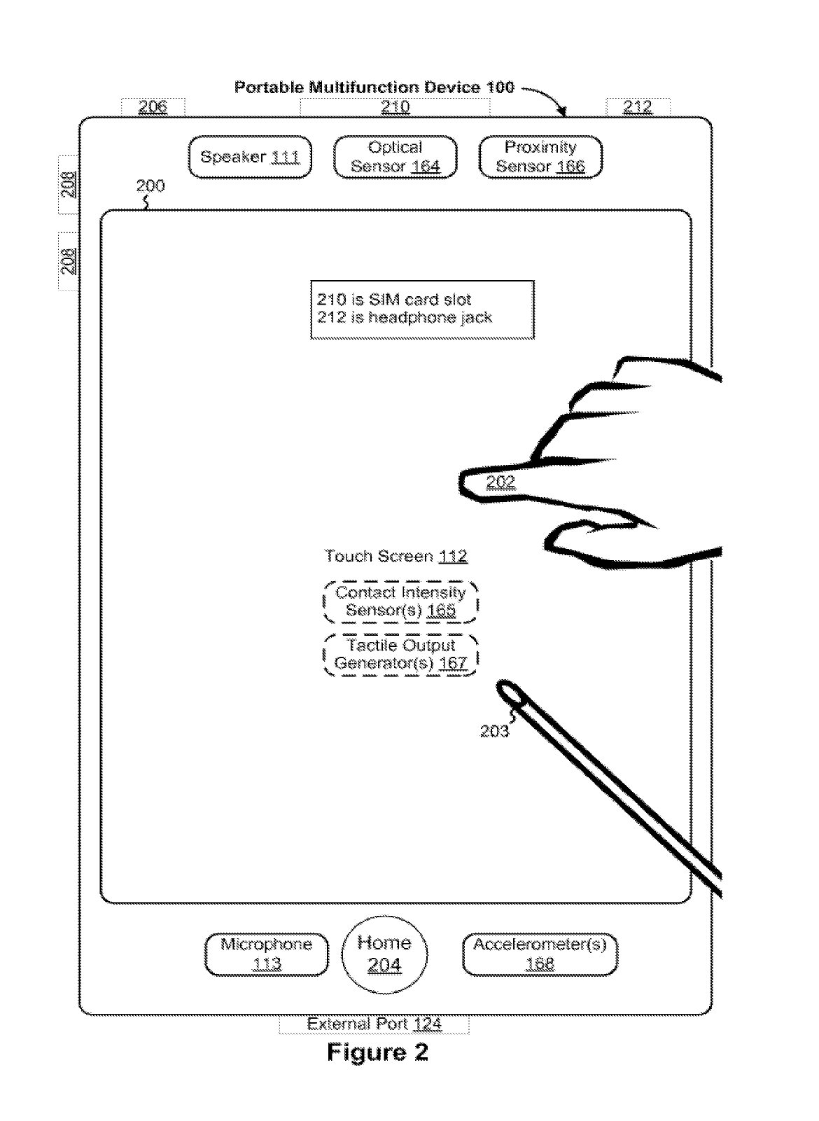

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, spaces between graphics, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in some embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device, so that the touch screen display is enabled for use as a viewfinder for still and/or video image acquisition. In some embodiments, another optical sensor is located on the front of the device so that the user's image is, optionally, obtained for videoconferencing while the user views the other video conference participants on the touch screen display.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is coupled to input controller 160 in 1/0 subsystem 106. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIGS. IA and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and optionally is adjusted without changing the physical hardware of device 100). For example, a mouse “click” threshold of a trackpad or touch screen display optionally is set to any of a large range of predefined thresholds values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that is capable of being displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 are, optionally, used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 are, optionally, used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 are, optionally, used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some embodiments, the menu button is a physical push button or other physical input control device instead of a touchpad.

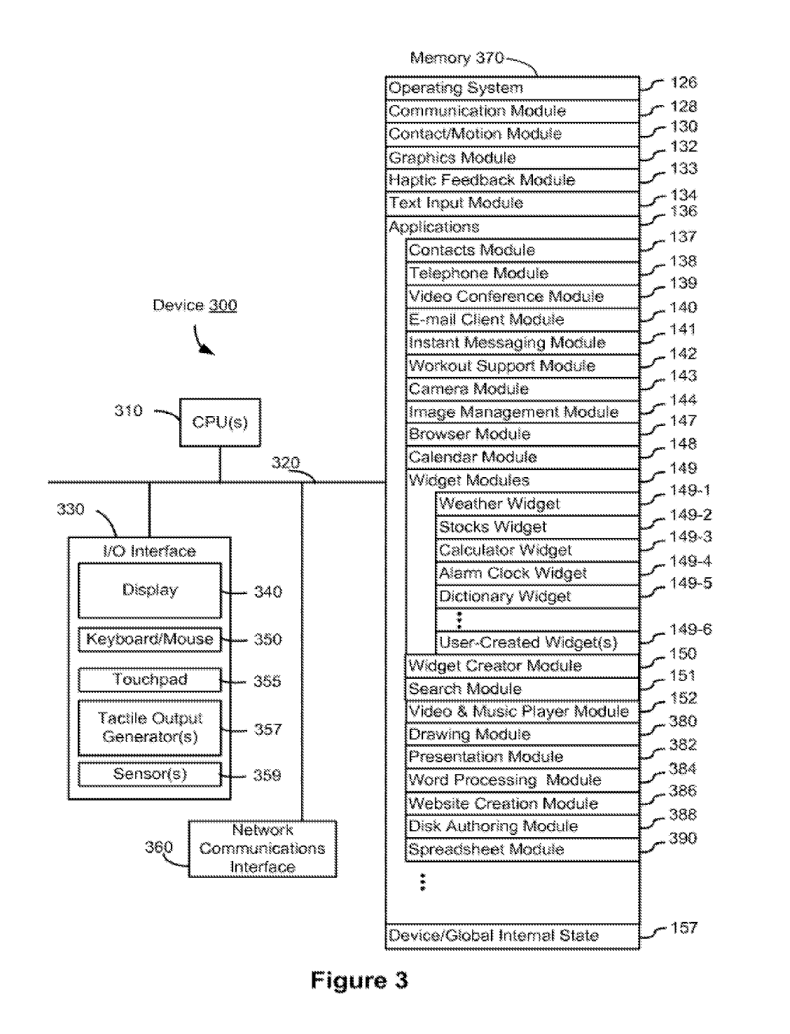

FIG. 1B is a block diagram illustrating exemplary components for event handling in accordance with some embodiments. In some embodiments, memory 102 (in FIG. IA) or 370 (FIG. 3) includes event sorter 170 (e.g., in operating system 126) and a respective application 136-1 (e.g., any of the aforementioned applications 137-13, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for output by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. However, in some embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. However, in some embodiments, active event recognizer determination module 173 determines that all views that include the physical location of a sub-event are actively involved views, and therefore determines that all actively involved views should receive a particular sequence of sub-events. In some embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. However, in some embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In some embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for output on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In some embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. IA). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that is, optionally, implemented on portable multifunction device 100.

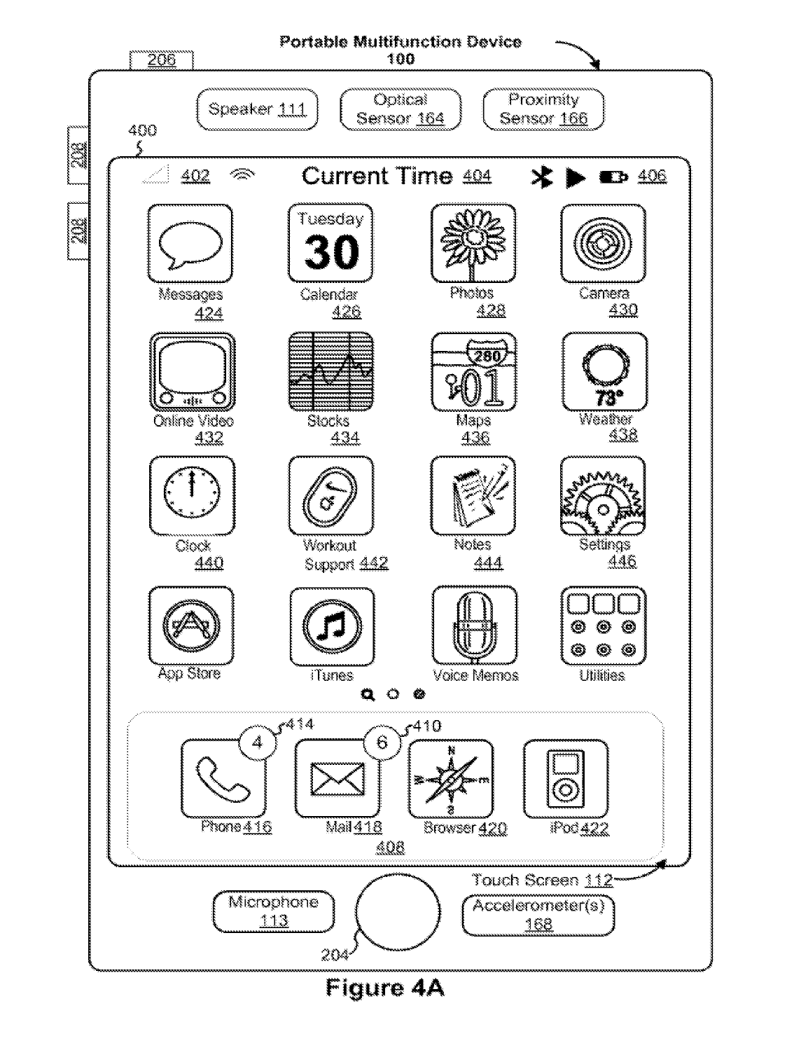

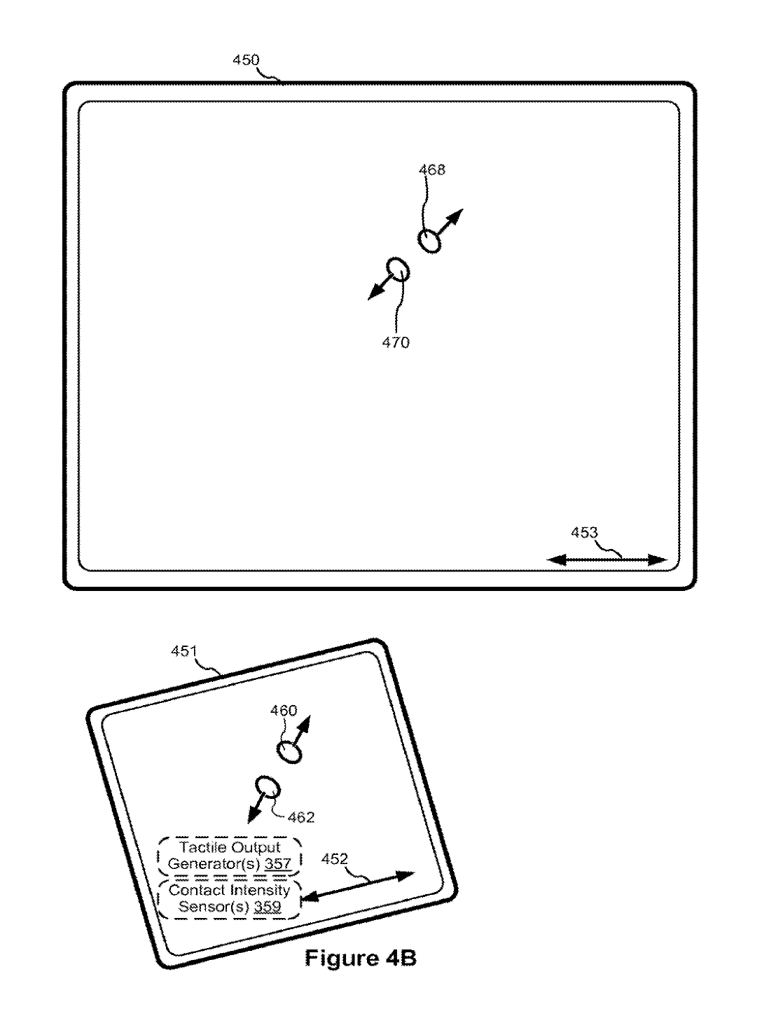

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Text;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video”
   Icon 434 for stocks widget 149-2, labeled “Stocks;”
   Icon 436 for map module 154, labeled “Map;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 357) for detecting intensity of contacts on touch-sensitive surface 451 and/or one or more tactile output generators 359 for generating tactile outputs for a user of device 300.

Although some of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or touch screen 112 in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

### Exemplary Method for Displaying a GUI on a Device

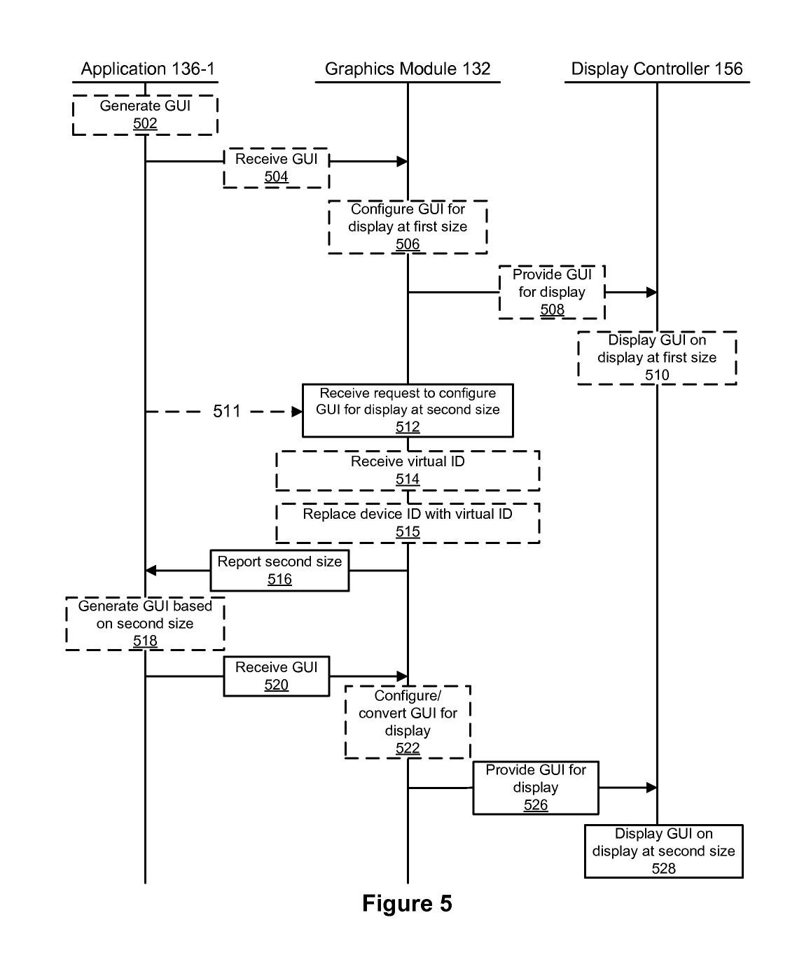

Attention is now directed towards embodiments of a process that optionally are implemented on an electronic device with a display, such as device 300 or portable multifunction device 100. FIG. 5 is an interaction diagram illustrating a method for displaying a GUI on a device, in accordance with some embodiments. The interaction diagram illustrates interactions among the application 136-1, the graphics module 132, and the display controller 156, in accordance some embodiments. The application 136-1, which optionally is a first-party application or a third-party application, is replaced with the operating system 126 on the device according to some embodiments without straying from the inventive concepts disclosed herein. In some embodiments, the interaction diagram can include additional or alternative actions or actors, or include the illustrated actions in a different order without straying from the scope of the disclosed invention.

According to some embodiments, the process begins at step 502, per the following description. However, in some embodiments, the process begins at step 512 or 516, as described below. The application 136-1 generates 502 a GUI. The application 136-1 can generate any relevant GUI that includes any combination of text, image, video, or other conventional graphics. The application 136-1 sends the GUI to the graphics module 132.

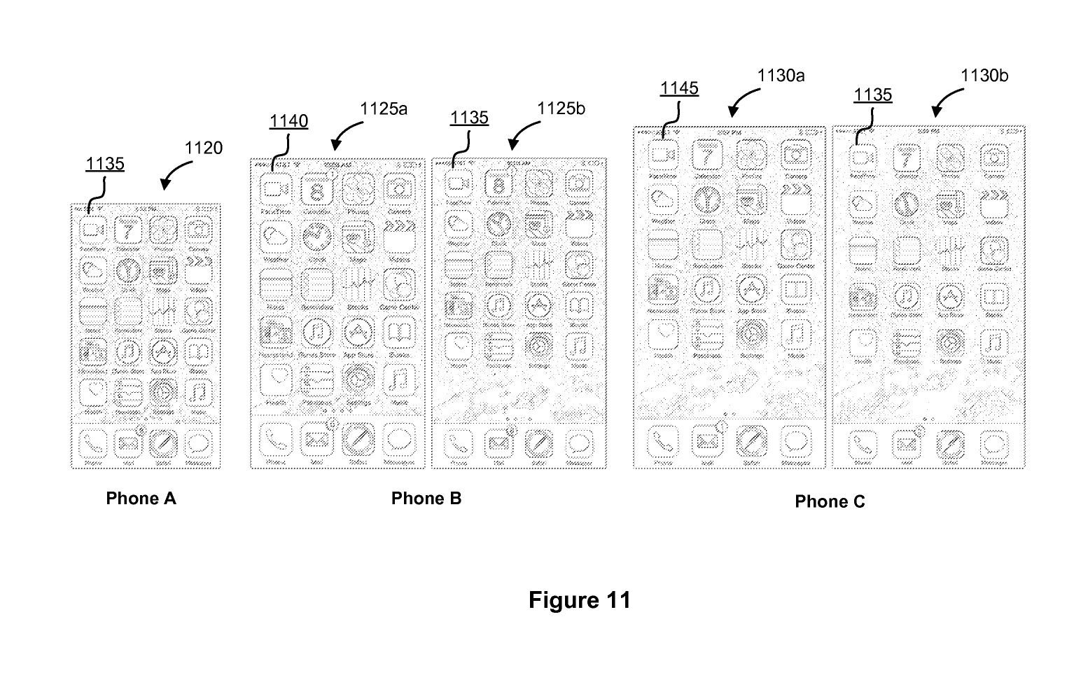

The graphics module 136-1 receives 504 the GUI, according to some embodiments. The graphics module 132 configures 506 the GUI for display on a display of a first size. In some embodiments, the first size is the size of the display 340 on the device 100. For example, the GUI as shown in FIG. 11 for Phone A (showing UI 1120), Phone B (showing UI 1125b), and Phone C (showing UI 1130b), each of which are shown with application icons at a native size of the display corresponding to the device size. However, the first size is not necessarily the same size as the size of the GUI. The first size optionally is the native size of the display. The native size of the display corresponds to the physical dimensions of the display 340. The size indicates the size of the display 340 in length dimensions (e.g., 3″×5″), or in any other apparent dimensions. The first size optionally is associated with a first pixel density. The first pixel density is indicated in pixels per inch (ppi), dots per inch (dpi), or any other relevant unit, according to some embodiments. In some embodiments, the pixel density of the GUI configured for display on the display at the first size is higher than the maximum pixel density of the display 340. This density reduces the number of graphical defects and visual artifacts when the pixel density of the GUI is decreased. In some embodiments, the pixel density of the GUI is decreased when the GUI is configured for display on a display of a different size than the first size.

In some embodiments, the graphics module 132 configures 506 the GUI for display on a display of the first size based on a device ID stored in the device's memory 102. The device ID corresponds to a device with a display of the first size. The device ID optionally corresponds to a type of device (e.g., a device with a particular screen size), or to a specific device. In some embodiments, the device ID corresponds to a specific model or type of electronic device. For example, there is a device ID associated with the display of an iPhone® from Apple Inc. of Cupertino, Calif., a different device ID associated with the display of an iPad® from Apple Inc. of Cupertino, Calif., and so forth. The device ID optionally indicates the native size of the display 340 of the device 100. In some embodiments, the graphics module 132 identifies the size of the display 340 based on the device ID and configures the GUI for display on a display of the identified size. However, in some embodiments, the graphics module 132 marks or selects the virtual device ID 132 as the device ID to send to the application.

The graphics module 132 provides 508 the configured GUI for display on the display of the first size. In some embodiments, the GUI is provided to the display controller 156 for display on a touch-sensitive display system 112, i.e., a touch-screen. The display controller 156 can provide the GUI for display on any type of display 340 or combination of displays on the device 100. In some embodiments, the display controller 156 provides the GUI for display on multiple displays 340 on the device 100 or connected devices. The GUI, configured for display on the display of the first size, is displayed 510 on the display 340 of the device 100.

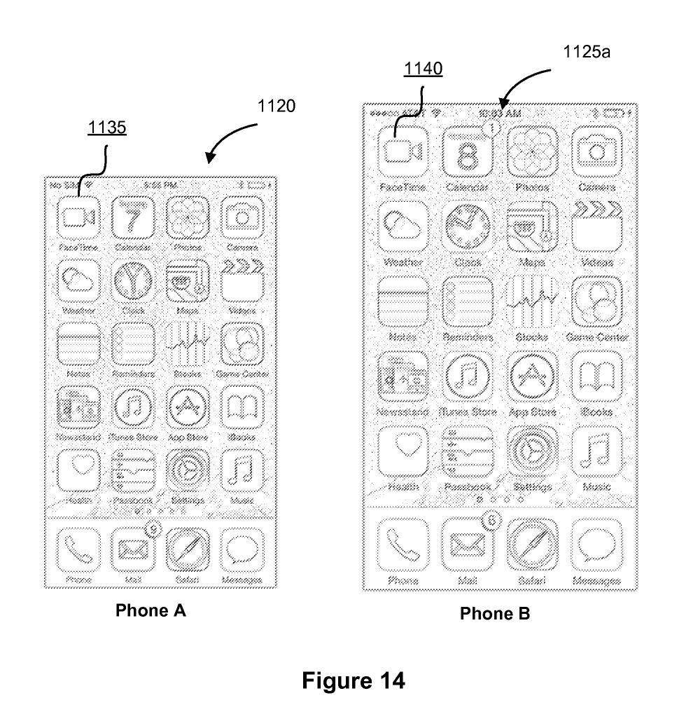

The graphics module 132 optionally receives 512 a request to configure the GUI for display on the display of a second size, according to some embodiments. However, according to some embodiments the method begins at step 516. The second size corresponds to a different display size than the first size. In some embodiments, the second size is larger than the first size. For example, the request optionally is to configure the GUI for display on a second display with a larger sized display. This can include displaying a tablet-size GUI on a smartphone screen or displaying a laptop-size GUI on a tablet screen. In some embodiments, the second size is smaller than the first size. This can include displaying a GUI configured for display on a smartphone screen on a tablet screen, for example. FIG. 14 shows an example, where the GUI of Phone B (1225a) displays a GUI corresponding to a smaller device size, e.g., that of Phone A (showing UI 1120). Thus, the icons 1140 of Phone B, showing UI 1125a, appear larger in size than standard icons 1135.

In some embodiments, a different pixel density is associated with the second size than the pixel density associated with the first size. In some embodiments, the second size corresponds to the size of a second display configured on a second device. For example, if the first size corresponds to a display on an iPhone® from Apple Inc. of Cupertino, Calif., the second size can correspond to a display on an iPad® from Apple Inc. of Cupertino, Calif. or any other relevant electronic device. Alternatively, the sizes can correspond to differently sized phones that are part of a common product line and run the same operating system, e.g., as shown in FIG. 11, Phone A has a 4″ diagonal screen, Phone B has a 4.7″ diagonal screen, and Phone C has a 5.5″ diagonal screen. According to some embodiments, phones A-C are part of a common product line and run the same operating system. The graphics module 132 receives 512 the request from one of the application 136-1 (dotted line 511), the operating system 126, or the user (e.g., through touch-screen 112). For example, the request optionally is generated in response to receiving a user-initiated contact or contacts on the touch-screen 112. The contact optionally is a gesture on the touch-screen 112, the user selecting a user interface element on the touch-screen 112, or any other relevant contact. The user input can optionally be from a physical user interface (e.g., a button, a switch, etc.) configured on the device 100.

The graphics module 132 optionally receives 514 a virtual device ID. The virtual device ID is a device ID corresponding to a second display of the second size. In some embodiments, the display optionally is a virtual canvas. The virtual canvas is a virtual display stored in virtual memory on the device 100. The virtual device ID corresponds to a physical device with a physical display 340 at the second size according to some embodiments, but in some cases may not correlate with any one specific second sized device.

The graphics module 132 replaces 515 the device ID with the virtual ID. The graphics module 132 replaces 515 the device ID by overwriting, de-selecting, or otherwise replacing the device ID with the virtual ID in response to receiving the virtual ID. In some embodiments, the preexisting device ID (e.g., the device ID for device 100) is not overwritten. Instead, the graphics module 132 selects the virtual device ID as the device ID to send or report to the application 136-1.

In some embodiments, step 516 is the first step in the process. The graphics module 132 reports 516 the second size to the application 136-1. The graphics module 132 optionally reports 516 the second size responsive to selecting the virtual device ID for reporting to the application 136-1 or responsive to a request from the application 136-1. As previously stated, the application 136-1 optionally is a first-party application (e.g., Mail, Contacts, Calendar, Phone), a third-party application, or the operating system 126. The graphics module 132 reports 516 the second size to the application 136-1 to inform the application 136-1 that the GUI will be displayed on a display 340 of the second size. In some embodiments, the graphics module 132 reports to the application 136-1 and/or operating system 126 that the display 340 on the device 100 has physical dimensions of the second size instead of the first size.

In some embodiments, the application 136-1 generates 518 the GUI based on the second size. The application 136-1 generates 518 the GUI for display on a display of the second size. This, for example, could mean that the application 136-1 generates 518 a GUI that has dimensions corresponding to the available screen real estate on the display of the second size. The GUI optionally is generated 518 by the same application 136-1 that initially generated 502 the GUI. Returning briefly to the example shown in FIG. 14, the GUI for Phone A is generated to fit the screen real estate of Phone B, according to some embodiments.

The graphics module 132 receives 520 the GUI and optionally configures 522 the GUI for display on the display at the second size. According to some embodiments, the configuring comprises converting the GUI generated by the application from a GUI configured for display on a display of the second size to a GUI configured for display on a display of the first size. As previously mentioned, the display of the second size can correspond to a physical display or a virtual display. In some embodiments, configuring 522 the GUI for output on the display of the second size includes configuring or scaling the display size of the GUI. For example, the GUI optionally is scaled, using an algorithm, such that the size of the GUI matches the available screen real estate of the display of the second size. The scaling is based on the difference between the first size and the second size. In some embodiments, the GUI configured for display on the display of the first size replaces the GUI configured for display on the display of the second size.

In some embodiments, configuring or converting 522 the GUI for output on the display of the second size includes mapping the GUI to a virtual canvas. The virtual canvas, as previously described above, is a virtual representation of the display stored in memory 102. The virtual canvas is of the second size. For example, the virtual canvas can have the same size, resolution, and/or pixel density as the display of the second size. The GUI is mapped, for example, such that the size of the GUI matches the size of the virtual canvas. The device 100 uses a mapping algorithm to map the GUI to the virtual canvas. In some embodiments, configuring 522 the GUI includes adding, removing, moving, or otherwise modifying graphics on the GUI. Since the GUI configured for display on the display of the second size is larger (or smaller) than the GUI configured for output at the first size, the GUI configured for display on the display of the second size may need to be cropped, expanded, or otherwise made to fit on the screen real estate available on the display 340 at the first size. In some embodiments, the application 136-1 crops the GUI by removing icons, images, text, space between graphics, or other graphics from the GUI for display on the display of the second size. The application 136-1 selects a set of one or more graphics to remove from the GUI. In some embodiments, the application 136-1 removes the graphics based on how frequently icons are selected, what hardware is enabled on the device 100, or what graphics are most relevant to the GUI. However, in some embodiments, the cropped graphics are pre-selected based on the size the GUI is configured to be displayed at. The GUI is cropped based on a cropping algorithm that accounts for at least one of the first size, the second size, and the difference between the sizes.

In some embodiments, the application 136-1 configures 522 the GUI for display on the display of the second size by adding graphics to the GUI. For example, if the GUI configured for display on the display of the second size is bigger than the GUI configured for display of the display of the first size, the GUI can optionally add icons, images, text, space between icons, or other graphics to the GUI. The graphics are added based on how frequently the graphics are used, what hardware is enabled on the device 100, or what graphics are most relevant to the GUI. The added graphics optionally are pre-selected based on the first size, the second size, the difference between the sizes, or all three. Graphics are added to the GUI based on an algorithm that accounts for at least one of the first size, the second size, and the difference between the sizes.

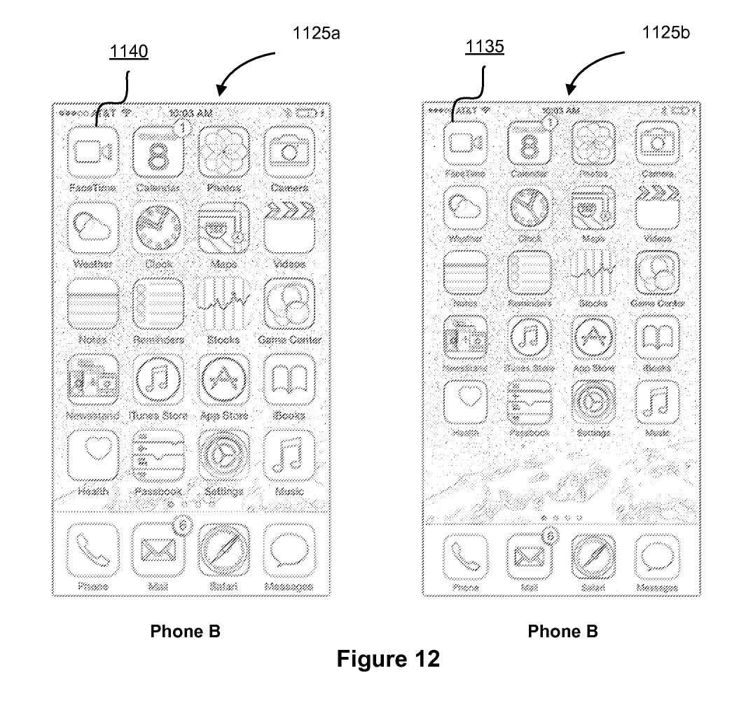

The graphics module 132 provides 526 the GUI for display on the display of the second size, according to some embodiments. The graphics module 132 provides 526 the GUI to the display controller 156 for display on the display 340 of the first size. The GUI, configured for display on a display of the second size, is displayed 528 on the display 340 of the first size. For example, FIG. 12 depicts portable multifunction device Phone B showing user interfaces 1125a and 1125b with two differently sized sets of application icons and other display elements. User Interface 1125b on Phone B shows standard, first size icons 1135 and other display elements, whereas user interface 1125a shows larger icons 1140 on Phone B resulting from the display of the second size being displayed.

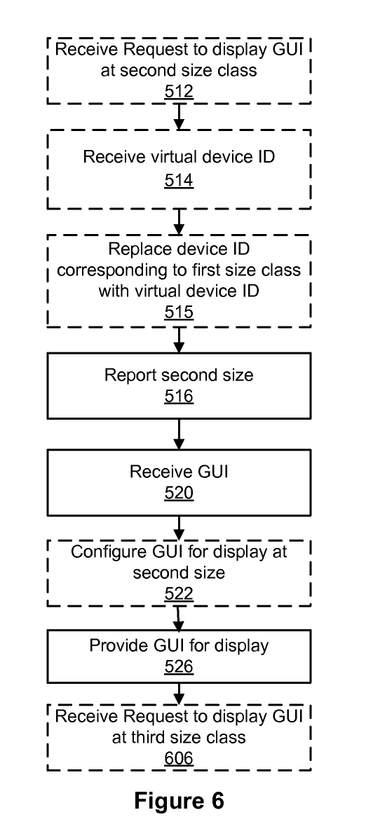

FIG. 6 is a flowchart illustrating a method for generating a display on a mobile device, in accordance with some embodiments. The flowchart illustrates actions performed by the graphics module 132, in accordance to some embodiments. However, the method of FIG. 6 optionally is performed by any other hardware or software component of the portable multifunction device 100. Some embodiments of the method for generating a display include additional or alternative actions or include the illustrated actions in a different order without straying from the scope of the disclosed invention.

The graphics module 132 optionally receives 512 the request to configure the GUI for display on a display of the second size. The request optionally is generated by the user via the touch-sensitive display system 112, by the application 136-1 (e.g., a first-party or third-party application; dotted line 511), or by the operating system 126. In some embodiments, the user can select which display size they want the GUI configured for display at. For example, a user can opt to display the GUI for display on a display of a predetermined larger size or for display on a display of a predetermined smaller size.

Optionally, the graphics module 132 receives 514 the virtual device ID that identifies the second size. The virtual device ID is associated with a second device having a display with dimensions of the second size. In some embodiments, the virtual device ID is received in response to receiving 512 the request to configure the GUI for output on a display at the second size.

In some embodiments, in which the graphics module 132 receives 514 the virtual device ID, the graphics module 132 optionally replaces 515 the device ID corresponding to the display 340 of the first size with the virtual device ID. The graphics module 132 can overwrite the physical device ID in memory 102 with the virtual device ID. However, in some embodiments, the graphics module 132 marks the virtual device ID as active and marks the physical device ID, associated with the display at the first size and also stored in memory 102, as inactive. In some embodiments, the graphics module 132 selects the virtual device ID as the device ID to report to the application 136-1.

According to some embodiments, the method begins by the graphics module 132 reporting 516 the second size. In some embodiments, the graphics module reports 516 the second size to one of the application 136-1, the operating system 126, or the software program responsible for generating the GUI. This reporting optionally is accomplished by sending the virtual device ID to the application 136-1 or operating system 126 responsible for generating the GUI.

The graphics module 132 receives 520 the GUI. In some embodiments, the received 520 GUI is generated by the application 136-1 based on the reported second size. For example, the application 136-1 generates the GUI such that the size of the GUI matches the available screen real estate of the display of the reported size.

The graphics module 132 optionally configures 522 the GUI for display on a display of the second size. In some embodiments, configuring 522 the GUI for display on the display of the second size includes mapping the GUI to a virtual canvas. The virtual canvas, as previously described above, is a virtual representation of the display stored in memory 102. In some embodiments, the graphics module 132 determines the size virtual canvas based on the virtual device ID. The graphics module 132 sizes the virtual canvas such that the size of the virtual canvas is of the second size. For example, the virtual canvas can have the same size, resolution, and/or pixel density as the display of the second size. The GUI is mapped, for example, such that the size of the GUI matches the size of the virtual canvas. The device 100 uses a mapping algorithm to map the GUI. In some embodiments, the GUI is mapped to the virtual canvas, having the first size. Returning to the example shown in FIG. 14, the GUI for Phone A (UI 1120) is generated to fit the screen real estate of Phone B, according to some embodiments.

In some embodiments, the graphics module 132 configures 522 the GUI by rendering the GUI at the second size. The graphics module 132 can render the GUI for display on the display at the second size using any conventional rendering algorithm or hardware.

In some embodiments, configuring 522 the GUI for display on the display of the second size includes converting the GUI generated by the application from a GUI configured for display on a display of the second size to a GUI configured for display on a display of the first size. In some embodiments, converting can include other modifications to the GUI as described in the configuring 522 step. The graphics module 132 provides 526 the GUI configured for display on the display of the second size. The graphics module 132 provides the GUI to the display controller 156, which controls one or more displays 340 at the first size. In some embodiments, the display controller 156 provides the GUI for output on the touch-screen 112. The touch-screen 112 has dimensions of the first size. In some embodiments, the display controller 156 provides the GUI for output on multiple displays 340 connected to the display controller 156.

The graphics module 132 optionally receives 606 a request to configure the GUI for display on a display of a third size. The third size is different than the first size and the second size. In response to receiving 606 the request to configure the GUI for display on a display of the third size, the graphics module 132 displays the GUI, configured for display on a display of the third size, according to the method disclosed above.

The graphics module 132 allows for switching to an application that generates a GUI for display on a display of the first size or the second size. The graphics module 132 receives a request to switch from a first application to a second application. Both applications are installed or running on the device 100. The first application is an application generating a GUI that is being provided for display on the device. The request to switch applications optionally is responsive to the user selecting the second application; for example, the user can select an icon on the touch-screen 112 that is associated with the second application. In some example embodiments, in which the device 100 is to display the GUI at the second size, the graphics module 132 reports the second size to the second application. Responsive to reporting the second size, a GUI associated with the second application is received by the graphics module 132. The GUI is generated based on the second size The GUI associated with the second application is provided for display to the display controller 156. The GUI configured for display on a display of the second size is displayed on the display 340 at the first size, with appropriate rendering to re-fit to the second size as necessary.

In some embodiments, in which the device 100 is to display the GUI for display on a display of the first size, the graphics module 132 reports the first size to the second application. Responsive to reporting the first size, a GUI associated with the second application is received. The size of the GUI is configured for display on a display of the reported first size. The GUI associated with the second application is provided for display, optionally to the display controller 156. The GUI for display on the display of the first size is displayed on the display 340 of the first size. For example, FIG. 12 depicts portable multifunction device Phone B showing user interfaces 1125a and 1125b with two differently sized sets of application icons and other display elements, according to some embodiments. User interface 1125b shows standard, first size icons 1135 and other display elements, whereas user interface 1125a shows larger icons 1140 resulting from the display of the second size being displayed.

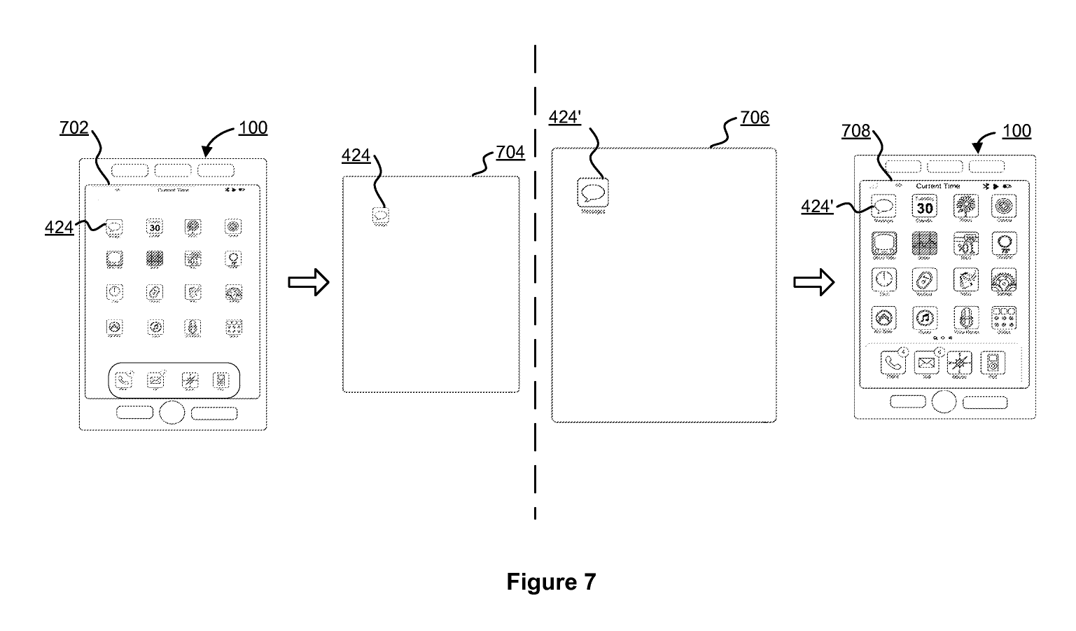

FIG. 7 illustrates GUIs during a process for generating a GUI for display on the display of the second size by changing the display size of graphics in the GUI, in accordance with some embodiments. FIG. 7 illustrates the first GUI 702 on the device 100 before the GUI is configured for display on the display of a second size, a virtual canvas at the first size 704, the virtual canvas at the second size 706, and the GUI 708, configured for display on a display of the second size, on the device 100 after configuring the GUI.

The first GUI 702 is displayed on the display 340 at a first size. In some embodiments, the pixel density associated with the first size is higher than the maximum pixel density of the display 340. The GUI 702 comprises one or more graphics, such as messages icon 424.

The GUI 702 is mapped to a virtual canvas 704 for display on a display of the first size. The virtual canvas 704 optionally is a virtual display stored in the device memory 102. The graphics of the GUI 702, such as messages icon 424, are mapped to the virtual canvas 704 for display to a display of the first size. Only messages icon 424 is shown on the virtual canvas 704 for simplicity. However, any number of graphics can be mapped to the virtual canvas 704. For example, each graphic of the GUI 702 can be mapped to the virtual canvas 704.

The virtual canvas 704 is configured as the virtual canvas 706 for display on the display of the second size. The virtual canvas 706 has different dimensions than the virtual canvas 704 at the first size. The virtual canvas 704 for display to the display of the first size is configured for out display put on the display of the second size responsive to the graphics module 132 configuring 522 the GUI for display on the display of the second size. In some embodiments, the virtual canvas 704 is configured by scaling the virtual canvas such that the size or resolution of the virtual canvas matches available space for display on the display of the second size. However, in some embodiments, the graphics module 132 generates a second virtual canvas 706 for display on the display of the second size. The graphics module 132 either selects the second virtual canvas 706 for output or replaces the virtual canvas 704 with the second virtual canvas 706 in memory 102. Each graphic on the virtual canvas 704 is similarly included on the virtual canvas 706. However, each graphic, such as messages icon 424′, is configured for display at the second size. In some embodiments, each graphic is configured for display on the display of the second size by scaling the graphic by a scaling factor, based on the difference between the first size and the second size. A scaling algorithm can scale the graphics or virtual canvas by the scaling factor. Since the second size is larger in the illustrated embodiment, messages icon 424′ is larger than messages icon 424 (displayed on the virtual canvas 704 at the first size).

In some embodiments, the second size is associated with a second pixel density, different from the first pixel density. By configuring the GUI for display on the display of the second size, the pixel density of the GUI is changed. This means that if the GUI for display on the display of the second size is output on the display 340 at the same resolution as the GUI for display on the display of the first size, the GUI will have different physical dimensions. Therefore, the device 100 can configure the GUI for display on the display of the second size by configuring or scaling the virtual canvas 704, having a first pixel density, to the virtual canvas 706, having a second pixel density. In some embodiments, the device 100 can configure the GUI for display by changing the pixel density of the virtual canvas 704 from the first pixel density to the second pixel density. In these embodiments, the resolution of the virtual canvas 704 and the virtual canvas 706 optionally is the same.

In some embodiments, the size of the graphics is increased by increasing the resolution of one or more graphics in the GUI. For example, messages icon 424 is at the first size. In some embodiments, messages icon 424′ is displayed at a second resolution, higher than the first resolution. By displaying messages icon 424′ at a higher resolution, messages icon 424′ appears bigger than messages icon 424. The first pixel density is higher than the native resolution of the device, such that no graphical defects or visual artifacts appear when the graphic is displayed at a higher second resolution and lower second pixel density. In some embodiments, the second pixel density of the GUI at the second size is still at or above the native pixel density for the display 340.

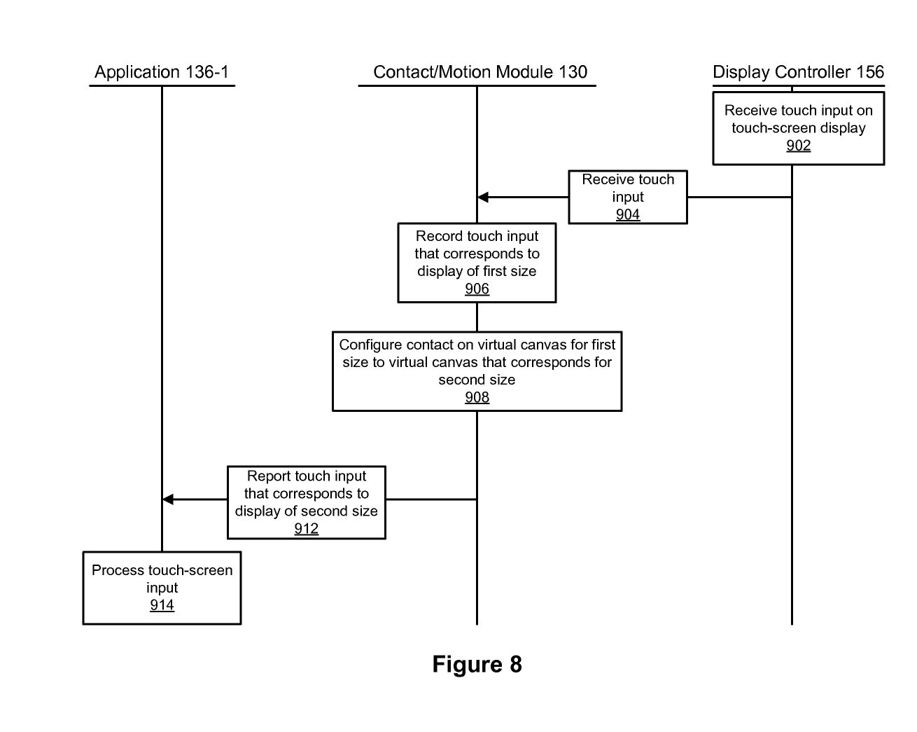

FIG. 8 is an interaction diagram illustrating a method for processing touch input on a display, in accordance with some embodiments. The interaction diagram illustrates interactions among the application 136-1, contact/motion module 130, and the display controller 156, in accordance with some embodiments. However, the application 136-1 is optionally replaced with the operating system 126 in some embodiments without straying from the inventive concepts disclosed herein. Some embodiments of the interaction diagram can include additional or alternative actions or include the illustrated actions in a different order without straying from the scope of the disclosed invention.

The display controller 156 receives 902 touch input. The display controller 156 receives touch input through one or more touch-screens 112 configured on the device 100. The touch input is input by a user onto a touch-screen 112 that displays the GUI. The GUI is configured for display on the display of the second size and but is displayed on the touch-screen 112, which is of the first size. The touch input comprises one or more contacts on the touch-screen 112. The touch input includes coordinates of the contact on the touch-screen 112. The touch-screen 112 optionally receives motions or gestures associated that comprise the touch input.

While the coordinates of the contact or contacts are received on the touch-screen 112 of the first size, the coordinates of the contact may not correspond to the GUI displayed on the display 340, since the GUI is configured for display on a display of the second size. Thus, the device 100 needs to process the touch-screen input to match the GUI by configuring the touch-screen input to the second size.

The contact/motion module 130 receives 904 the touch input. Responsive to receiving the touch input, the contact/motion module 130 maps 906 the touch input to a virtual canvas. In some embodiments, the virtual canvas optionally is the same virtual canvas 704 used to configure 522 the GUI. The virtual canvas has the first size and has the same dimensions of the display 340.

The contact/motion module 130 records 906 touch input with respect to the virtual canvas. The virtual canvas corresponds to the display of the first size. In some embodiments, the touch-screen contact is recorded by determining a set of coordinates that identify the location of the contact on the touch-screen 112 of the first size. In embodiments in which the contact is a gesture or a motion, the speed and direction of the contact can also be determined. The coordinates correspond to a location on the virtual canvas of the first size 704. The coordinates are recorded by storing the coordinates in memory 102. In some embodiments, this includes mapping the coordinates of the contact to the virtual canvas corresponding to the display of the first size.

The contact/motion module 130 configures 908 the contact/movement on the virtual canvas that corresponds to the display of the first size to a virtual canvas that corresponds to the display of the second size. For example, the configuring 908 comprises reporting, to the application for some embodiments, the touch input with respect to a virtual canvas that corresponds to a touch-screen display of the second size instead of the first size. In some embodiments, the configuring 908 is based on the size difference between the first size and the second size. For example, a scaling algorithm can determine a scaling factor based on the first size and the second size and scale the resolution, pixel density, or size of the virtual canvas to correspond to a display of the second size. The contact/motion module 130 reports 912 the touch input that corresponds to the display of the second size to the application 136-1. The application 136-1 processes 914 the touch input. Processing the touch input enables the application 136-1 to receive touch input on a GUI configured for display on a display at the second size.

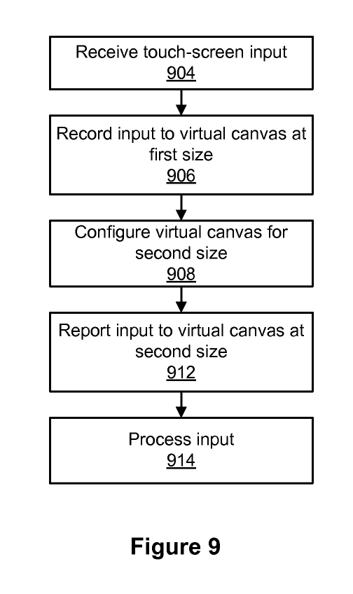

FIG. 9 is a flowchart illustrating a method for receiving touch input on a display, in accordance with some embodiments. The flowchart illustrates actions performed by the contact/motion module 130, in accordance with some embodiments. However, the method of FIG. 9 optionally is performed by any other component of the portable multifunction device 100. Some embodiments of the method for receiving touch input can include additional or alternative actions or include the illustrated actions in a different order without straying from the scope of the disclosed invention.

The contact/motion module 130 receives 904 the touch input. Responsive to receiving the touch-screen input, the contact/motion module 130 records 906 the touch input to a virtual canvas corresponding to the display of the first size. The virtual canvas corresponds to the display 340 on the device 100, wherein the display is of the first size. In some embodiments, the virtual canvas optionally is the same virtual canvas 704 used to configure the GUI for output. The contact/motion module 130 generates the virtual canvas by determining the coordinates for the contact and recording the coordinates of the contact to memory 102. In some embodiments, the coordinates for the contact are recorded by mapping or plotting the coordinates of the contact on the virtual canvas. The contact/motion module 130 optionally configures the virtual canvas for the second size 908, with the contact or movement of the contact on the virtual canvas corresponding to the display of the first size configured to a virtual canvas corresponding to the display of the second size. For example, the configuring 908 comprises reporting, to the application for some embodiments, the touch input with respect to a virtual canvas that corresponds to a touch-screen display of the second size instead of the first size. In some embodiments, the contact/movement virtual canvas is configured by converting the dimensions, resolution, or pixel density of the contact on the first size canvas to the virtual canvas to match the second size (e.g., the pixel density of the second size, the resolution of the second size, etc.). The configuring optionally uses any apparent scaling algorithm, according to some embodiments.

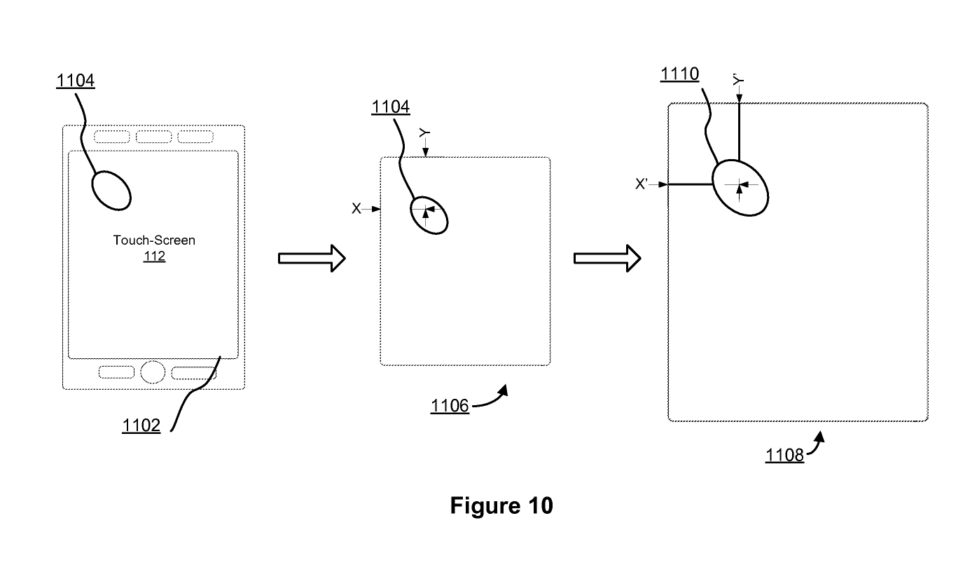

FIG. 10 illustrates receiving touch input on a GUI, in accordance with some embodiments. FIG. 10 illustrates touch input 1104 on the GUI 1102, the touch input on the virtual canvas corresponding to the display of the first size 1106, and the touch input 1110 on the virtual canvas corresponding to the display of the second size 1108.

The touch input is received on the touch-screen 112 of the first size. The touch-screen 112 displays the GUI 1102. The GUI 1102 is configured for display on a display at the second size. The touch input optionally is received on one or more touch-screens 112 on the device 100. The touch input is illustrated as a single contact 1104 in FIG. 10 for simplicity. However, the touch input is comprised of any number of contacts, gestures, or motions on the touch-screen 112.

The touch input is recorded with respect to a virtual canvas 1106 corresponding to the display of the first size. The virtual canvas is a virtual display configured for display on the display of the first size, the same size of the touch-screen 112. The touch-screen input 1104 is mapped to the virtual canvas 1106. In some embodiments, a set of coordinates are determined for the touch input in the form of the contact 1104. The coordinates are mapped to the virtual canvas 1106. In the illustrated example, the coordinates of the contact 1104 are (X,Y).

The device 100 configures the contact or movement on the virtual canvas corresponding to the display of the first size 1106 to a virtual canvas corresponding to the display of the second size 1108. For example, the configures comprises reporting, to the application for some embodiments, the touch input with respect to a virtual canvas that corresponds to a touch-screen display of the second size instead of the first size.

The touch input corresponding to the display of the second size is reported to the application 136-1 that generates the GUI. The application 136-1 processes the touch input. This allows the device 100 to receive touch input on a GUI for output on the display of the second size, e.g., at point 1110.

FIG. 11 depicts three different portable multifunction devices (Phones A, B, and C), each displaying an exemplary user interface (1120, 1125, 1130, respectively) for a menu of applications, according to some embodiments. Phones A, B, C each include some or all of the components as described in conjunction with device 100 and/or 300, according to some embodiments.

In some embodiments, Phones A, B, C have three different size displays: Phone A has a 4″ diagonal screen, Phone B has a 4.7″ diagonal screen, and Phone C has a 5.5″ diagonal screen. According to some embodiments, Phones A-C are part of a common product line and run the same operating system.

Some portable multifunction devices, e.g., Phones B and C, are capable of displaying a user interface with application icons and other display elements at two different sizes: a first, standard size, and a second, larger size, according to some embodiments. In some embodiments, the portable multifunction devices are capable of displaying user interfaces at more than two sizes (e.g., three or more different sizes). For example, user interface 1125b displays icons 1135 at the first, which is the standard size, and is the same size as the icons 1135 of user interface 1120 and icons 1135 of user interface 1130b. User interface 1125a displays icons 1140 at a second, larger size, as does user interface 1130a, with larger icons 1145. Thus, Phone B and Phone C can display the icons at either the smaller size 1135 or a larger size 1140, 1145, depending on which UI is displayed. Larger icons 1140, 1145 are differently numbered to indicate that while both larger in size, the larger size may not be the same across different devices (e.g., Phones B and C).

FIG. 12 depicts Phone B showing user interfaces 1125a and 1125b with two differently sized sets of application icons and other display elements, according to some embodiments. User interface 1125b is shown with application icons 1135 at the first, standard size, which is the native size of the display corresponding to the device size of Phone B, e.g., a 4.7″ diagonal screen, according to some embodiments. User interface 1125a is shown with application icons 1140 at the second, larger size, which corresponds to a differently sized display, according to some embodiments. Settings are provided in some embodiments that allow the user of Phone B to switch between displaying a user interface with standard 1135 or larger 1140 sized icons, e.g., to switch between UI 1125a and 1125b. As described in the methods herein, according to some embodiments Phone B reports to an application or operating system that its display, which is of a first size corresponding to standard sized icons 1135, is instead a display of a second, different size. For example, the second size is associated with a device ID different from the device ID of Phone B. The second size device ID optionally corresponds to a type of device (e.g., a device with a particular screen size), or to a specific device (e.g., user interface 1125a in FIG. 14 is generated when Phone B displays the user interface using the device ID of Phone A instead of the device ID of Phone B). Based on the device ID provided, the device receives, from the application or operating system, a user interface generated based on the second size, according to some embodiments. Thus, the received user interface (e.g., 1125a) is sized for a size that is different from the actual size of the display of Phone B. When the user interface 1125a is displayed on Phone B, it is configured for a different sized device, causing the icons 1140 and other display elements to appear larger.

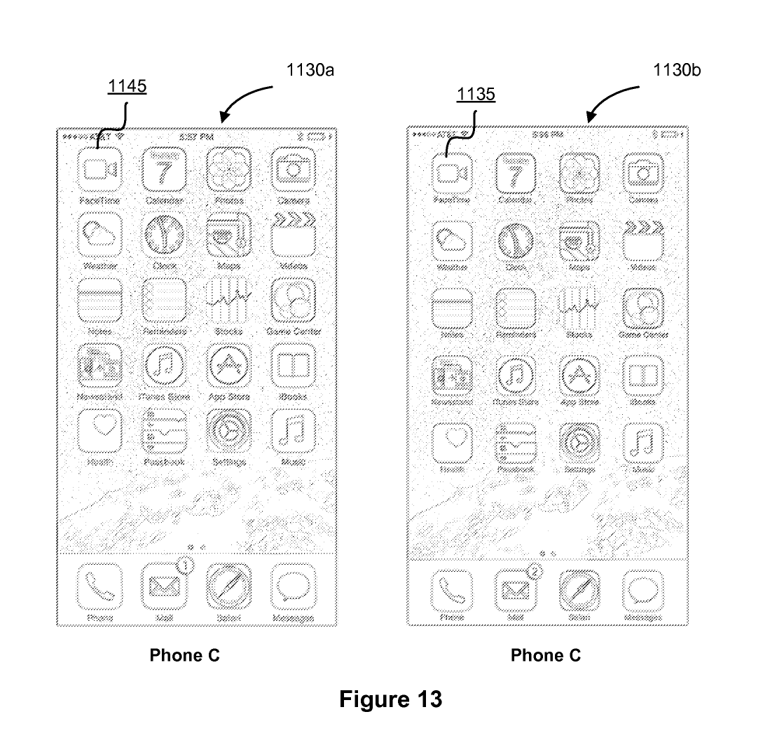

FIG. 13 depicts Phone C showing user interfaces 1130a and 1130b with two differently sized sets of application icons and other display elements, according to some embodiments. Phone C with UI 1130a is shown with application icons 1135 at the first, standard size, which is the native size of the display corresponding to the device size of Phone C, e.g., a 5.5″ diagonal screen, according to some embodiments. Phone C is also shown with UI 113b with application icons 1145 at the second, larger size, which corresponds to a differently sized display, according to some embodiments. Settings are provided in some embodiments that allow the user of Phone C to switch between displaying a user interface with standard 1135 or larger 1145 sized icons. As described in the methods herein, according to some embodiments Phone C reports to an application or operating system that its display, which is of a first size corresponding to standard sized icons 1135, is instead a display of a second, different size. For example, the second size is associated with a device ID different from the device ID of Phone C (e.g., user interface 1130a in FIG. 13 is generated when Phone C displays the user interface using the device ID of Phone B instead of the device ID of Phone C). The second size device ID optionally corresponds to a type of device (e.g., a device with a particular screen size), or to a specific device. Based on the device ID provided, the Phone C receives, from the application or operating system, a user interface generated based on the second size, according to some embodiments. Thus, the received user interface is sized for a size that is different from the actual size of Phone C. When the user interface 1130a is displayed on Phone C, it is configured for a different sized device, causing the icons 1145 and other display elements to appear larger.

FIG. 14 depicts portable multifunction device, Phone B with UI 1125a, side by side with portable multifunction device, Phone A with UI 1120, according to some embodiments. The portable multifunction devices Phones A, B are shown in different sizes, e.g., with Phone A having a 4″ diagonal screen and Phone B having a 4.7″ diagonal screen.

Portable multifunction device Phone A is shown with UI 1120 with application icons 1135 at the first, standard size, which is the native size of the display corresponding to the device size, e.g., a 4″ diagonal screen, according to some embodiments. Portable multifunction device Phone B, with UI 1125a, is shown with application icons 1140 at the second, larger size, which corresponds to a differently sized display, according to some embodiments. In this example, device Phone B reports to an application or operating system that its display, which is of a first size corresponding to standard sized icons 1135, is instead a display of a second, different size, e.g., the size of device Phone A. Based on this information, Phone B receives, from the application or operating system, a user interface 1125a generated based on the second size, according to some embodiments. Here, the user interface 1125a is generated for the device designated as Phone A. Thus, the received user interface is sized for a size that is different from the actual size of Phone B, in this case a smaller device Phone A. As can be seen by comparing the icons 1135 of Phone A and the larger icons 1140 of Phone B, the icons 1140 are merely enlarged version of the icons 1135 sized to fit the larger of Phone B. When the user interface 1125a is displayed on the Phone B, it is configured for Phone A, causing the icons 1140 and other display elements to appear larger, even though both devices are generating a user interface based on the same device ID (e.g., a device ID of Phone A).

In some embodiments, the icons 1140 and other display elements on Phone B appear larger in size, as if they have been stretched. For example, the proportions remain the same as on Phone A, e.g., the spaces in between icons 1140 are similar in proportion to the icons 1140 as are the spaces in between icons 1135 to those icons 1135. As described elsewhere herein, Phone A optionally is associated with a first pixel density and is higher than the maximum pixel density of the display of Phone A, according to some embodiments. This density reduces the number of graphical defects and visual artifacts when the pixel density of the user interface is decreased, for example, by enlarging the user interface to fit a larger size, such as that of Phone B.

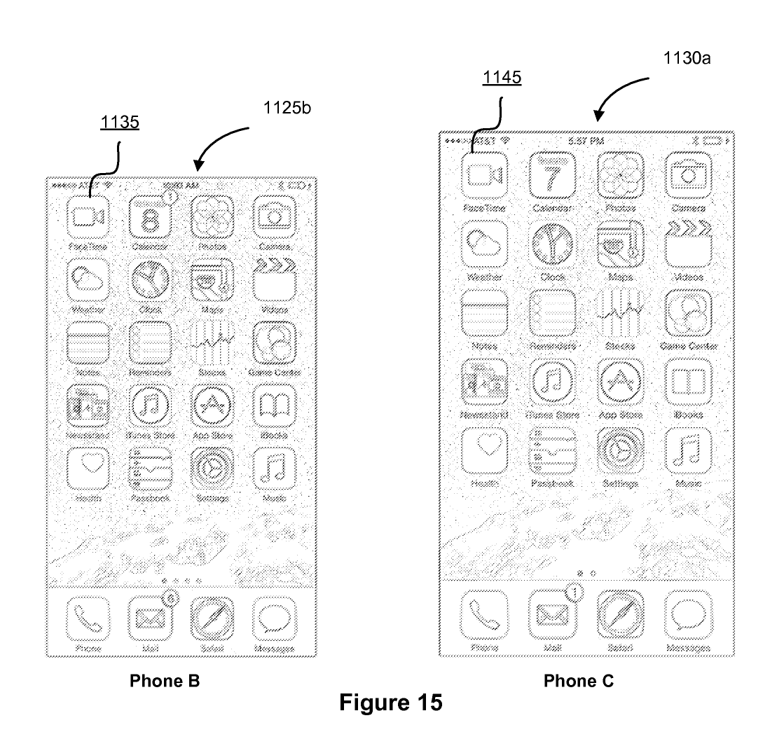

FIG. 15 depicts portable multifunction device Phone B, with UI 1125b, side by side with portable multifunction device Phone C, with UI 1130a, according to some embodiments. The portable multifunction devices (Phones B, C) are shown in different sizes, e.g., with Phone B having a 4.7″ diagonal screen and Phone C having a 5.5″ diagonal screen.

Phone B is shown with application icons 1135 at the first, standard size, which is the native size of the display corresponding to the device size of Phone B, e.g., a 4.7″ diagonal screen, according to some embodiments. Phone C is shown with application icons 1145 at the second, larger size, which corresponds to a differently sized display, according to some embodiments. In this example, Phone C reports to an application or operating system that its display, which is of a first size corresponding to standard sized icons 1135, is instead a display of a second, different size, e.g., the size of Phone B. Based on this information, Phone C receives, from the application or operating system, a user interface generated based on the second size, according to some embodiments. Here, the user interface is generated for Phone B. Thus, the received user interface is sized for a size that is different from the actual size of Phone C, in this case a smaller device Phone B. As can be seen by comparing the icons 1135 of Phone B and the larger icons 1145 of device Phone C the icons 1145 are merely enlarged version of the icons 1135 sized to fit the larger screen of Phone C. When the user interface is displayed on Phone C, it is configured for Phone B, causing the icons 1145 and other display elements to appear larger, even though both devices are generating a user interface based on the same device ID (e.g., a device ID of Phone B).

In some embodiments, the icons 1145 and other display elements on Phone C appear larger in size, as if they have been stretched. For example, the proportions remain the same as on Phone B, e.g., the spaces in between icons 1145 are similar in proportion to the icons 1145 as are the spaces in between icons 1135 to those icons 1135. As described elsewhere herein, Phone B optionally is associated with a first pixel density and is higher than the maximum pixel density of the display of Phone B, according to some embodiments. This density reduces the number of graphical defects and visual artifacts when the pixel density of the user interface is decreased, for example, by enlarging the user interface to fit a larger size, such as that of Phone C. An additional advantage provided by this approach to increasing the size of a user interface is that in a product line with multiple devices having different display sizes (e.g., Phones A, B, and C), application developers have already worked to ensure that their applications look good (e.g., ensuring that content of the application is are appropriately laid out so that text is legible and elements of the user interface are not overlapping into each other), and thus using different device IDs to prompt the application to generate a user interface that can be scaled up to a larger size enables the device to leverage this work from application developers to provide enlarged user interfaces for their applications without requiring the application developers to do additional work to support the feature (e.g., by supporting three different display sizes, an application developer is already supporting enlarged user interfaces for the two larger devices, which can enlarge the user interfaces generated for the smaller displays of the smaller devices).

### Additional Considerations

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Any of the steps, operations, or processes described herein optionally are performed or implemented with one or more hardware or software modules, alone or in combination with other devices. In some embodiments, a software module is implemented with a computer program product comprising a computer-readable medium containing computer program code, which optionally is executed by a computer processor for performing any or all of the steps, operations, or processes described.

Embodiments of the invention may also relate to an apparatus for performing the operations herein. This apparatus optionally is specially constructed for the required purposes, and/or it may comprise a general-purpose computing device selectively activated or reconfigured by a computer program stored in the computer. Such a computer program optionally is stored in a tangible computer readable storage medium or any type of media suitable for storing electronic instructions, and coupled to a computer system bus. Furthermore, any computing systems referred to in the specification optionally includes a single processor or architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

What is claimed is:

1. A computer-implemented method, comprising:
at a device having a display, wherein the display has a first size:
reporting, to an application configured on the device, the size of the display as a second size, different from the first size;
receiving a GUI from the application, the GUI generated based on the second size; and
displaying the GUI, the GUI configured for output on a display at the second size, on the display having the first size.

2. The computer-implemented method of claim 1, further comprising:
after receiving the GUI generated based on the second size and prior to displaying the GUI, converting the GUI generated by the application from a GUI configured for display on a display of the second size to a GUI configured for display on a display of the first size.

3. The computer-implemented method of claim 1, wherein the first size is the native size of the display of the device and corresponds to the physical dimensions of the display of the device.

4. The computer-implemented method of claim 1, wherein the first size corresponds to a size of the display of the device and wherein the second size corresponds to a size of a display of a second device.

5. The computer-implemented method of claim 1, further comprising:
receiving a virtual device ID corresponding to a device with a display of the second size; and
replacing, on the device, a physical device ID corresponding to a device with the display of the first size with the virtual device ID.

6. The computer-implemented method of claim 5, wherein reporting the size of the display as the second size further comprises:
reporting the virtual device ID to the application instead of the physical device ID.

7. The computer-implemented method of claim 1, wherein configuring the GUI for output on the display at the second size is based on both the first size and the second size.

8. The computer-implemented method of claim 1, wherein the second size is larger than the first size.

9. The computer-implemented method of any of claim 1, wherein the second size is smaller than the first size.

10. The computer-implemented method of claim 1, wherein the GUI is comprised of one or more graphics, and configuring the GUI for output on a display at the second size further comprises:
determining a set of graphics to modify; and
modifying the set of graphics of the GUI based on at least one of the first size or the second size.

11. The computer-implemented method of claim 10, wherein modifying the set of graphics includes at least one of adding or removing the set of graphics that comprise the GUI.

12. The computer-implemented method of claim 1, further comprising:
receiving a request to switch from the application configured on the device to a second application configured on the device;
reporting the second size to the second application;
receiving from the second application a GUI generated based on the second size; and
displaying the GUI that was received from the second application.

13. The computer-implemented method of claim 1, further comprising:
receiving a request to switch from the application configured on the device to a second application;
reporting the first size to the second application;
receiving, from the second application, a GUI generated based on the first size; and
displaying the GUI that was received from the second application.

14. The computer-implemented method of claim 13, wherein the GUI generated based on the first size is displayed at the same resolution as the GUI configured for output on the display of the second size.

15. The computer-implemented method of claim 1, wherein the display is a touch-screen, further comprising:
receiving touch input from the touch-screen display while displaying the GUI configured for output on the display of the second size;
recording the touch input with respect to a virtual canvas that corresponds to a touch-screen display of the first size; and
reporting, to the application, the touch input with respect to a virtual canvas that corresponds to a touch-screen display of the second size.

16. A non-transitory computer readable storage medium storing one or more programs, the one or more programs comprising instructions, which when executed by an electronic device with a touch screen display, cause the electronic device to:
reporting, to an application configured on the device, the size of the display as a second size, different from the first size;
receiving a GUI from the application, the GUI generated based on the second size; and
displaying the GUI, the GUI configured for output on a display at the second size, on the display having the first size.

17. The non-transitory computer readable storage medium of claim 16, further comprising instructions for:
after receiving the GUI generated based on the second size and prior to displaying the GUI, converting the GUI generated by the application from a GUI configured for display on a display of the second size to a GUI configured for display on a display of the first size.

18. The non-transitory computer readable storage medium of claim 16, wherein the first size is the native size of the display of the device and corresponds to the physical dimensions of the display of the device.

19. An electronic device comprising:
a touch screen display;
one or more processors;
memory; and
one or more programs, wherein the one or more programs are stored in the memory and configured to be executed by the one or more processors, the one or more programs including instructions when executed by the electronic device cause the electronic device to:
report, to an application configured on the device, the size of the display as a second size, different from the first size;
receive a GUI from the application, the GUI generated based on the second size; and
display the GUI, the GUI configured for output on a display at the second size, on the display having the first size.

20. The electronic device of claim 19, wherein the first size is the native size of the display of the device and corresponds to the physical dimensions of the display of the device.
